(19) United States
(12) Patent Application Publication
(10) Pub. No.: US 2004/0097206 A1
(43) Pub. Date: May 20, 2004

(54) Circuit configuration for the frequency conversion of an oscillator frequency into a carrier frequency

(76) Inventors: Christian Grewing, Dusseldorf (DE); Andre Hanke, Dusseldorf (DE); Stefan Van Waasen, Duisburg (DE)

Correspondence Address: LERNER AND GREENBERG, PA, P O BOX 2480, HOLLYWOOD, FL, 33022-2480, US

(21) Appl. No.: 10/706,780

(22) Filed: Nov. 12, 2003

Related U.S. Application Data
(63) Continuation of application No. PCT/DE02/01698, filed on May 10, 2002.

(30) Foreign Application Priority Data
May 11, 2001 (DE) 101 22 919.4

(51) Int. Cl. H04B 1/00; H04B 17/02

(52) U.S. Cl. 455/139; 455/130

(57) ABSTRACT

A circuit configuration for the frequency conversion of an oscillator frequency into a carrier frequency includes a mixer, to which a signal with the oscillator frequency can be fed unchanged in its frequency at an input and can be fed divided-down in its frequency at a second input. The frequency division is, in this case, preferably a frequency division by four. The present circuit configuration has a particularly small area requirement, a particularly low current consumption, and is largely independent of fabrication tolerances. The present circuit configuration can be used with preference in mobile radio transceivers.

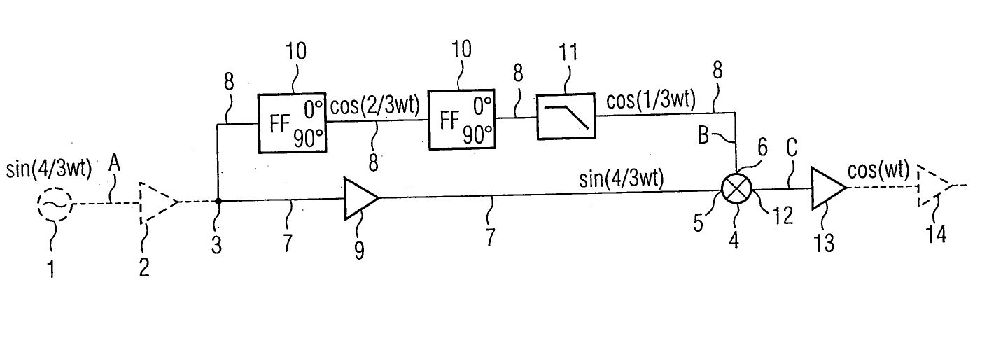

### CROSS-REFERENCE TO RELATED APPLICATION

This application is a continuation of copending International Application No. PCT/DE02/01698, filed May 10, 2002, which designated the United States and was not published in English.

### BACKGROUND OF THE INVENTION

1. Field of the Invention

The present invention relates to a circuit configuration for the frequency conversion of an oscillator frequency into a carrier frequency.

For wireless data transmission, as, for example, in the case of the so-called Bluetooth concept, transceivers (transmitter-receivers) are usually provided for the transmitting and receiving of modulated signals. For mixing up or down a signal with an oscillator frequency, provided by a local oscillator, into a carrier signal with a carrier frequency, it must be ensured, in the case of modern transmission concepts, that the oscillator frequency is not a higher harmonic of the carrier frequency on the transmission side. Otherwise, undesired disturbances of the, for example, voltage-controlled, oscillator would occur on account of feedback effects.

It is, for example, conceivable to feed to a frequency mixer a signal with an oscillator frequency with half the oscillator frequency at one input and with a quarter of the oscillator frequency at a further input. Accordingly, the mixer provides a signal with ¾ of the original oscillator frequency at its output. Also occurring at the mixer output is the undesired image frequency, which can be suppressed by configuring the mixer as an image-rejecting mixer, referred to as an image-reject (IR) mixer. The input signals of the mixer must, in this case, be carried as complex IQ signals. However, this means that the circuitry is complex and there is a relatively great chip area requirement. Moreover, the quality of the image rejection in the IR mixer is greatly dependent on fabrication tolerances in chip manufacture so that high expenditure in the manufacture or a high number of rejects in quality control have to be accepted.

Such subject matter is covered in German Published, Non-Prosecuted Patent Application 19928998 A1, in which it is shown a circuit configuration with an image-frequency-rejecting mixer that converts an oscillator signal into a transmit signal. For such a purpose, the oscillator signal is fed to the image-frequency-rejecting mixer with the oscillator frequency at one input and with a divided-down frequency at a further input.

In the case of the modern mobile radio concepts described, it is desirable to make possible transmitting and receiving circuits that have a particularly small chip area and low current consumption and that are also largely independent of production tolerances.

Therefore, when providing the carrier frequency, referred to as the transmit frequency, it is necessary to ensure that undesired signals and frequency components are suppressed and at the same time to manage with a small chip area and low current requirement.

### SUMMARY OF THE INVENTION

It is accordingly an object of the invention to provide a circuit configuration for the frequency conversion of an oscillator frequency into a carrier frequency that overcomes the hereinafore-mentioned disadvantages of the heretofore-known devices of this general type and that manages with a small chip area, has a low current consumption, and is of a simple construction.

With the foregoing and other objects in view, there is provided, in accordance with the invention, a circuit configuration for the frequency conversion of an oscillator frequency into a carrier frequency having a circuit node, to which a signal with the oscillator frequency can be fed, a mixer with a first input, a second input and with an output, a first signal path for coupling the circuit node and the first input of the mixer for the transmission of the signal with the oscillator frequency unchanged in its frequency, and a second signal path with a frequency divider, which is coupled on the input side to the circuit node and is coupled on the output side to the second mixer input, the frequency divider being configured for providing an output signal with a quarter of the frequency of the oscillator signal present at its input.

The frequency mixer in the case of the present circuit configuration mixes an oscillator signal transmitted unchanged in its frequency, which is provided by the first signal path, with a signal divided down in its frequency, which is, likewise, derived from the oscillator signal.

In such a case, the first input of the mixer, to which the signal is fed with the oscillator frequency unchanged, is, preferably, the switching local-oscillator input of the mixer, and the second input of the mixer, to which the signal is fed with the oscillator frequency divided down in its frequency, is, preferably, a linear signal input of the mixer.

The mixer provides at its output, on one hand, a signal with the difference frequency of the two input frequencies and, on the other hand, a signal with the sum frequency of the two difference frequencies, referred to as the image signal. With a low-pass filter, it is possible in a simple way to separate the lower useful signal frequency from the image frequency. In the case of the transmission frequencies of several GHz that are usually used for Bluetooth, a conventional buffer amplifier at the output of the mixer, which is usually present in any case for signal amplification, is sufficient to reject the image frequency, which is at a higher frequency level.

Accordingly, the mixer itself no longer has to be formed as an image-reject mixer, can, therefore, be constructed with a small chip area, and has a low current requirement. Moreover, the image frequency rejection is independent of the phase position of the in-phase and quadrature components of the frequency elements of the signals transmitted by the first signal path and the second signal path, which may vary as a result of production and fabrication variations. A further significant reduction in chip area is made possible by the resultant effect that it is possible to dispense with the need to carry the input signals of the mixer as IQ signals.

According to the present invention, the frequency divider is a divided-by-four divider and is configured for providing an output signal with a quarter of the frequency of the oscillator signal present at its input.

A divided-by-four divider can be realized with a particularly small chip area and a particularly simple construction. In such a case, the mixer provides at its output, on one hand, a signal with three-quarters of the oscillator frequency and, on the other hand, an image signal with five-quarters of the oscillator frequency. Accordingly, the oscillator frequency is not a higher harmonic of the carrier frequency so that no disturbances of the oscillator are produced by feedback effects.

For the numerical example for Bluetooth, this means that the local oscillator, for example, a voltage-controlled oscillator, has an oscillator frequency of 3.2 GHz. The mixer is provided, on one hand, with the oscillator frequency of 3.2 GHz at its first input and, on the other hand, with the oscillator frequency divided down in its frequency of 800 MHz, which results from division of 3.2 GHz by 4, at its second input. At the output of the mixer there is, accordingly, a signal that, on one hand, has the desired carrier frequency for Bluetooth of 2.4 GHz and, on the other hand, provides an image frequency of 4 GHz. For frequencies in the range of 4 GHz, however, currently customary buffer amplifiers, as are used at the output of up-conversion mixers in transceivers in mobile radio, already act as attenuators with an adequate low-pass effect so that the image frequency is effectively rejected.

In accordance with another feature of the invention, the frequency divider includes two divided-by-two dividers that are formed as flip-flops and are disposed one behind the other. Flip-flops that can be used for frequency division in the radio frequency range usually have two outputs, which have a phase shift of 90° in relation to each other. In the case of the present configuration, however, the signal present at the flip-flop on the output side does not have to be passed on as an IQ signal, as already explained. Preferably, the two frequency dividers formed as flip-flops are disposed one behind another in a signal flow direction and respectively provide at their output a signal with half a frequency of a signal present at their input.

In accordance with a further feature of the invention, the second signal path has a low-pass filter, which is disposed downstream of the frequency divider. The frequency division in the frequency divider usually produces higher harmonics, which are filtered out by suitable dimensioning of the low-pass filter and suitable setting of its cut-off frequency so that only the signal with the local-oscillator frequency divided by 4 is present at the input of the mixer, preferably, at its signal input.

In accordance with an added feature of the invention, there is provided an amplifier is connected for rejecting the image frequency obtained by adding the two frequencies present on the input side. Instead of the amplifier, preferably, a buffer amplifier, a suitably dimensioned low-pass filter could also be provided explicitly. This low-pass filtering at the output of the mixer brings about adequate attenuation of the image frequency prior to further processing in downstream stages of the circuit and makes it possible, in particular, to dispense with a complex and configuration of the frequency mixer as an image-frequency-rejecting mixer.

In accordance with a concomitant feature of the invention, there is provided an oscillator that is coupled to the circuit node is provided for providing the oscillator frequency. The oscillator, which is, preferably, formed as a voltage-controlled oscillator, in this case provides at its output an oscillator frequency that must be equal to 4/3 times the carrier frequency that is desired, in order in the special case of frequency division by four in the second signal path to obtain specifically the carrier frequency or the transmit frequency at the output of the mixer.

Other features that are considered as characteristic for the invention are set forth in the appended claims.

Although the invention is illustrated and described herein as embodied in a circuit configuration for the frequency conversion of an oscillator frequency into a carrier frequency, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWING

The FIGURE shows a simplified block diagram of a first embodiment of the circuit configuration according to the invention.

### DESCRIPTION OF THE PREFERRED EMBODIMENTS

Referring now to the single FIGURE of the drawing, a circuit configuration for the frequency conversion of an oscillator frequency into a carrier frequency is shown. This configuration includes a voltage-controlled oscillator 1, which is connected through a signal amplifier 2 to a circuit node 3. An up-conversion mixer 4 with a first input 5, formed as a local oscillator, and a second input, formed as a linear signal input 6, is coupled to the circuit node 3 through a respective signal path 7, 8. A first signal path 7 is formed such that the signal provided by the voltage-controlled oscillator 1 is available with the oscillator frequency A, unchanged in its frequency, at the first input 5 of the mixer 4. The signal with the oscillator frequency A is, in the present exemplary embodiment, a sinusoidal signal of the angular frequency 4/3ω, where ω= angular frequency of the desired carrier frequency. The first signal path 7 includes a signal amplifier 9. A second signal path 8 likewise connects the circuit node 3 to the mixer 4 and, for such a purpose, is connected to the second input 6 of the mixer 4, which is formed as a linear signal input. The second signal path 8 includes a series connection of two divide-by-two frequency dividers 10 and also a low-pass filter 11 for filtering out higher harmonics of the oscillator frequency caused by the frequency division 10. The divide-by-two frequency dividers 10 respectively provide at their output a signal with half the input-signal frequency. Accordingly, a signal B with a quarter of the frequency of the signal with the oscillator frequency A is provided at the input 6 of the mixer 4. In the present exemplary embodiment, this is a cosine signal with a third of the angular frequency ω of the carrier signal.

The frequency mixer 4 provides at its output 12 a signal that, on one hand, includes frequency elements that result from the difference of the frequencies of the input signals A, B and, on the other hand, includes image frequency elements that result from the sum of the frequency elements of the input signals A, B. The signal with the carrier frequency C at the output 12 of the mixer 4, accordingly, includes angular frequency elements of the angular frequency ω and also 5/3ω. The latter frequency elements are, in this case, image frequencies of the desired carrier with the frequency ω. The mixer 4 is not formed as an image-frequency-rejecting mixer. Rather, the undesired image frequency elements are rejected effectively in a buffer amplifier 13 connected to the output 12 of the mixer 4. For better attenuation of the image frequency, a further amplifier 14 may be disposed downstream of the buffer 13. In the present configuration, the signal paths 7, 8 are not configured as IQ signal paths for carrying complex signals.

In comparison with a configuration with image-frequency-rejecting mixing for the provision of a carrier frequency derived from an oscillator frequency, for example, with a frequency division by two in the first signal path and a frequency division by four in the second signal path, the circuit configuration described has the advantage that a significant reduction of around 40% can be achieved in the current consumption of the transmission path into a transceiver that can be used, for example, in mobile radio. At the same time, the circuit configuration described can be integrated on half the chip area in relation to the above configuration. Moreover, the image-frequency rejection described is subject to much smaller fabrication tolerances with respect to its performance. The output power of the circuit configuration described is also largely independent of fabrication tolerances. In the case of the present configuration, the rejection of the image frequency is not dependent on the phase positions of IQ components.

Because the present circuit configuration avoids the use of a toggle flip-flop for generating an IQ signal when dividing down the oscillator frequency, higher cut-off frequencies can be achieved in the transmission path of a mobile radio transceiver.

Instead of the amplifiers 13, 14 provided on the output side of the mixer 4, a low-pass filter may also be provided for the rejection of the image frequency.

We claim:

1. A circuit configuration for the frequency conversion of an oscillator frequency into a carrier frequency, comprising:
a circuit node for receiving a signal having the oscillator frequency;
a mixer having a first input, a second input, and an output;
a first signal path coupling said circuit node and said first input of said mixer for transmitting the signal with the oscillator frequency unchanged in the signal's frequency;
a second signal path containing a frequency divider having:
an input side coupled to said circuit node; and
an output side coupled to said second input of said mixer; and
said frequency divider providing an output signal at said output side having a quarter of a frequency of an oscillator signal present at said input side.

2. The circuit configuration according to claim 1, wherein said frequency divider is two frequency dividers formed as flip-flops disposed one behind another in a signal flow direction and respectively providing at their output a signal with half a frequency of a signal present at their input.

3. The circuit configuration according to claim 1, wherein said second signal path contains a low-pass filter.

4. The circuit configuration according to claim 1, wherein said second signal path contains a low-pass filter disposed downstream of said frequency divider in a signal flow direction.

5. The circuit configuration according to claim 2, wherein said second signal path contains a low-pass filter.

6. The circuit configuration according to claim 2, wherein said second signal path contains a low-pass filter disposed downstream of said two dividers in a signal flow direction.

7. The circuit configuration according to claim 1, further comprising an amplifier connected to said output of said mixer.

8. The circuit configuration according to claim 1, further comprising an amplifier connected to said output of said mixer for rejecting a higher beat frequency obtained by addition of frequencies of respective signals present at said first and second inputs of said mixer.

9. The circuit configuration according to claim 1, further comprising an oscillator coupled to said circuit node and providing the oscillator frequency.
